(19) United States
(12) Patent Application Publication
(10) Pub. No.: US 2006/0047562 A1
(43) Pub. Date: Mar. 2, 2006

(54) Method and apparatus for planning marketing scenarios

(76) Inventors: Ralph K. Kiefer, Bous (DE); Joerg W. Walzenbach, Voelkingen (DE); Petra Mueller, Saarbruecken (DE)

Correspondence Address: KENYON & KENYON, 1500 K STREET NW, SUITE 700, WASHINGTON, DC, 20005, US

(21) Appl. No.: 10/929,552

(22) Filed: Aug. 31, 2004

(51) Int. Cl. G06F 17/30

(52) U.S. Cl. 705/10

(57) ABSTRACT

A tool is proposed for planning marketing scenarios. Information is received that describes marketing elements, each of which is associated with a predicted result. Information is also received that groups the marketing elements into competitive scenarios. A comparison of predicted results is calculated and output for scenarios that are based on the received information. After information is received modifying at least one of the scenarios, a comparison of predicted results is calculated and output for the scenarios as modified.

### BACKGROUND

The present invention relates to planning of marketing scenarios. Marketing is the promotion of sales of a product or service, such as by advertising. A marketing scenario is a series of possible marketing campaigns with a common goal, each of which may comprise one or more activities. A business will typically adopt one or more marketing scenarios to promote its products. For example, a business XYZ Corp. may choose to promote its widgets by placing a series of advertisements in a particular newspaper and mailing coupons to a particular set of households.

As used herein, a “marketing element” is a marketing campaign and/or marketing activity. Marketing elements can form hierarchical structures and may comprise, for example, a campaign A which itself comprises campaign elements AA and AB. In this example, campaign A, campaign element AA, and campaign element AB are all marketing elements. Marketing elements may comprise different types of marketing activities.

There are usually many campaigns that a business may choose from when designing a marketing strategy. These campaigns each typically have associated costs, both in economic terms and in terms of impact on the organization that is engaging in the promotional campaign. In addition, these campaigns will typically have anticipated results, which may be based upon past experience or an estimate of likely outcomes. For example, placement of advertisements in a newspaper may cost a certain amount of money and reach N number of households, which may have been known to result in approximately S number of sales. The mailing of coupons to C households may costs less, but in the past may have resulted in a smaller number of sales. Because a business' promotional budget will always have some limits, a business cannot engage in all the marketing campaigns that are possible and must make selections among these campaigns. The present inventors have identified a need in the art for a tool that allows business planners to compare various marketing scenarios based on quantitative and qualitative information in a systematic way to formulate marketing strategies.

### BRIEF DESCRIPTION OF THE DRAWINGS

FIG. 1 is a simplified block diagram that illustrates a knowledge warehouse system including a marketing scenario application resident on a network according to an embodiment of the present invention.

FIG. 2 is a screen shot of a screen that illustrates a listing of marketing campaigns for a marketing scenario according to an embodiment of the present invention.

FIG. 3 is a screen shot of a screen that illustrates a planning screen in which a new marketing campaign may be added to a planning scope according to an embodiment of the present invention.

FIG. 4 is a screen shot of a screen that may be used to design marketing scenarios according to an embodiment of the present invention.

FIG. 5 is a screen shot of a screen that illustrates the editing of a marketing campaign according to an embodiment of the present invention.

FIG. 6 is a screen shot of a screen that illustrates reports for different scenarios according to an embodiment of the present invention.

FIG. 7 is a flow chart that illustrates a method of planning marketing scenarios according to an embodiment of the present invention.

FIG. 8 is a simplified block diagram that shows data relationships according to an embodiment of the present invention.

FIG. 9 is a flow chart that illustrates a method of monthly forecasting from a scenario planning point of view according to an embodiment of the present invention.

FIG. 10 is a simplified block diagram that shows data object relationships according to an embodiment of the present invention.

### DETAILED DESCRIPTION

Embodiments of the present invention provide methods and apparatus for marketing planning. Such a marketing scenario planner may be a software application program running on a computer network. A user may input or select information describing marketing campaigns and may group these campaigns into competitive scenarios. Based on predicted and/or known results, a comparison may be calculated and output for these scenarios. The user may then modify scenarios and cause new results to be calculated based on these modified scenarios.

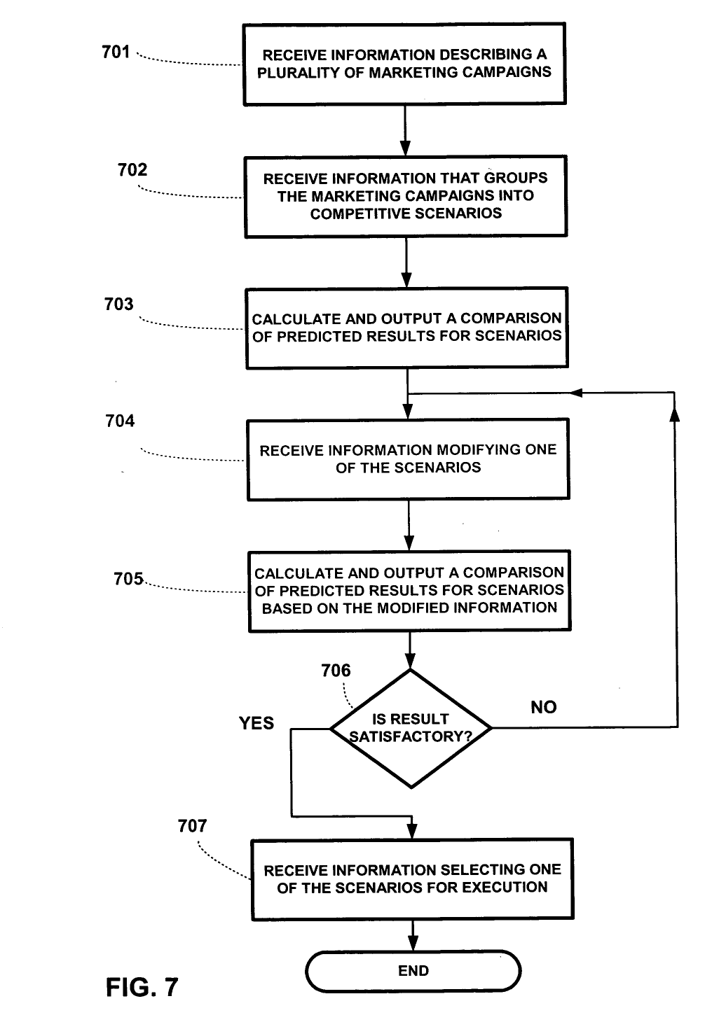

A marketing scenario planner according to an embodiment of the present invention may allow a user to model a number of different marketing scenarios by varying parameters such as the monetary cost, marketing segment, response rate, etc., to test expected results from different types of marketing actvities. By changing the parameters, a user may determine what the high-end (optimistic) and low-end (pessimistic) forecasted results are for each scenario. A user may also generate reports on the different scenarios and evaluate their usefulness. Such scenarios may be used as a basis for speculative analyses to compare alternative scenarios. As discussed with regard to FIG. 7, the scenario within a working set that is most likely to be executed may become the operative scenario, while all other scenarios may remain as alternative scenarios.

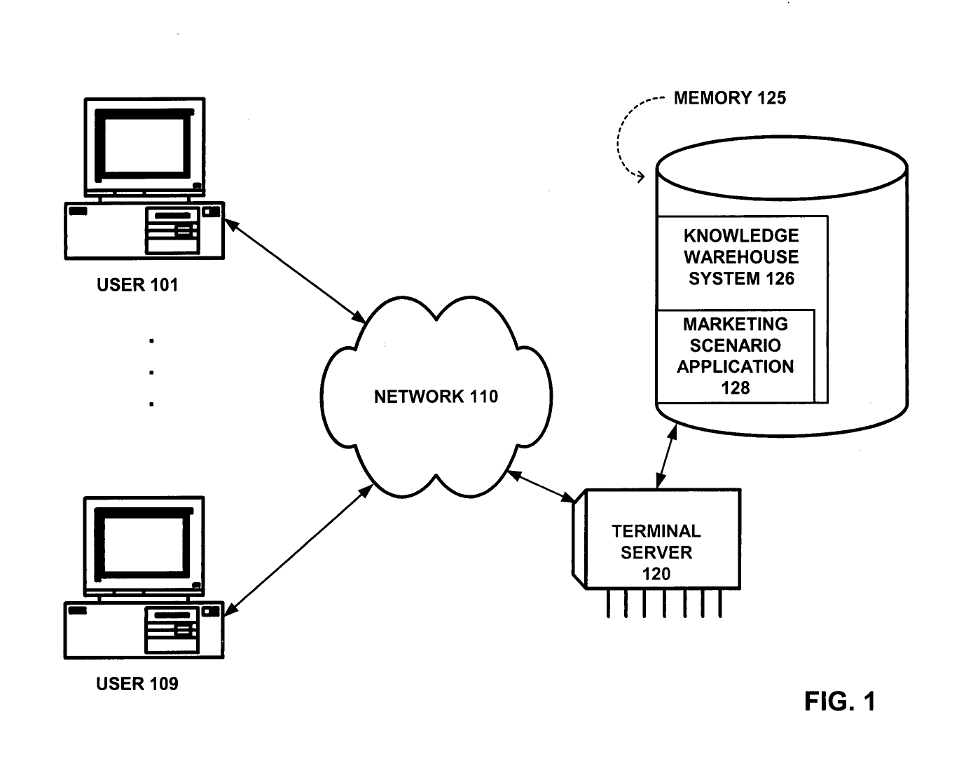

FIG. 1 is a simplified block diagram that illustrates a knowledge warehouse system including a marketing scenario application resident on a computer network according to an embodiment of the present invention. FIG. 1 shows a plurality of users 101-109 and a terminal server 120 coupled to a network 110. Network 110 may be any type of network for communicating information, such as a local area network (LAN), wide area network (WAN), the Internet, or an intranet. Users 101-109 may be any type of devices for running application software, such as for example a personal computer, a terminal, a personal digital assistant (PDA), etc. Terminal server 120 may be a computer that services users 101-109 over network 110. In another embodiment, a mainframe computer or other type of computer may be substituted for or used with terminal server 120. In the embodiment of FIG. 1, memory 125 is coupled to terminal server 120 to store instructions and data for a knowledge warehouse system 126. Memory 125 may be any type of computer readable medium, such as one or more hard disk memories. Knowledge warehouse system 126 may be a set of instructions that are executable by a processor for maintaining a collection of data that supports a decision making process. In the embodiment shown, knowledge warehouse system 126 includes marketing scenario application 128, which may be a software application that includes instructions to allow a user to perform marketing planning.

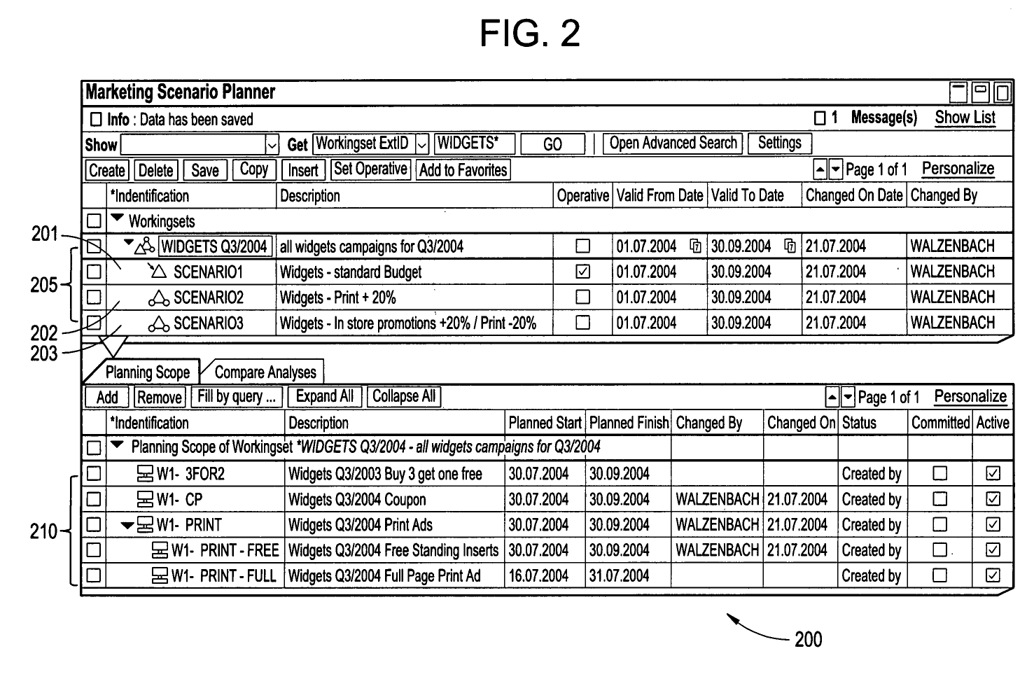

FIG. 2 is a screen shot of a screen 200 that illustrates a listing of marketing campaigns for a marketing scenario according to an embodiment of the present invention. Screen shot 200 is a screen that might be output by marketing scenario application 128 on the display of, for example, user 101. Screen shot 200 shows a group of marketing scenarios 205, which contains marketing scenarios 201-203, and a group of marketing campaigns in a planning scope 210. Planning scope 210 is a group of marketing campaigns that have been input and are available to be included in a scenario. In this example, marketing scenario 201 is the marketing scenario for the marketing of widgets using a standard budget, marketing scenario 202 is the marketing scenario for the marketing of widgets using a larger budget for print advertisements, and marketing scenario 203 is the marketing scenario for the marketing of widgets using a larger budget for in-store promotions and a smaller budget for print advertisements. Scenario 201 is the only operative scenario. The marketing campaigns in planning scope 201 consist of marketing campaigns such as marketing widgets with a buy 3 get one free campaign, a coupon campaign, a print add campaign, a free standing inserts campaign, and a full page print add campaign. In an embodiment, the marketing campaign may recorded as “committed” if a decision has been made to execute the marketing campaign. In the example shown in FIG. 2, none of the campaigns in planning scope have been committed, although all of these campaigns are active. In an embodiment, a user may add a marketing campaign, fill the planning scope by selecting an existing query, or remove existing marketing elements. Users may add marketing elements to a planning scope by adding the elements individually or executing a query and selecting them from the result list. In an embodiment, hierarchical coherencies may be shown on the screen.

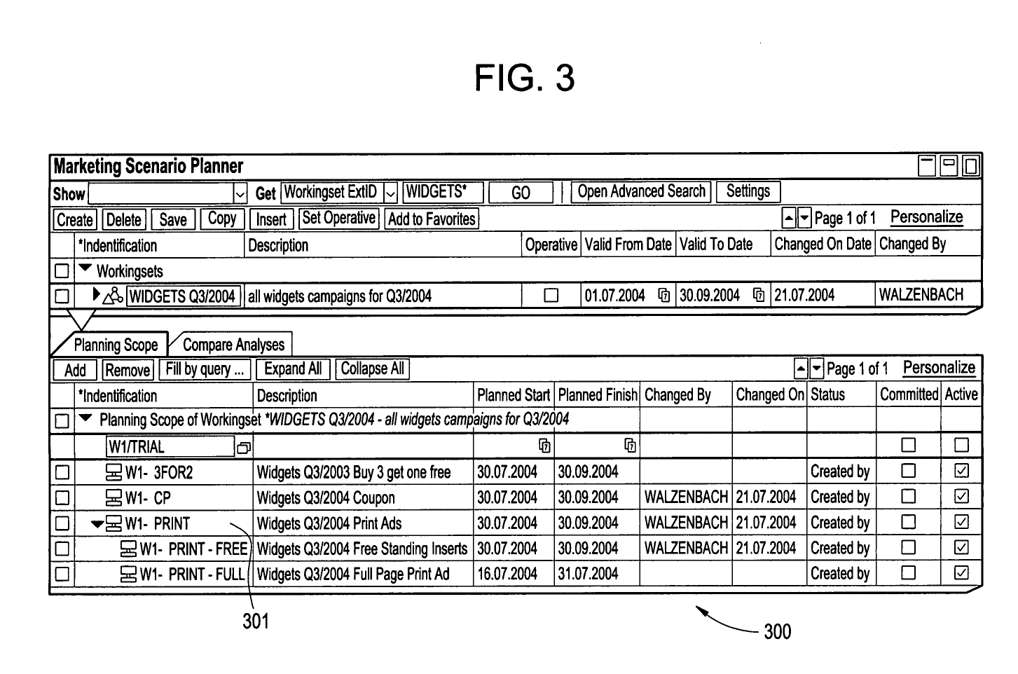

FIG. 3 is a screen shot of a screen 300 that illustrates a planning screen in which a new marketing campaign may be added to a planning scope according to an embodiment of the present invention. As shown, this screen may be used to input a marketing campaign, such as print campaign 301, to a planning scope, from where it may then be added to a scenario. In an embodiment, the marketing campaigns may be arranged in a hierarchy, with one marketing campaign being a unit or part of another campaign. In the example shown, the marketing campaign 301 contains a free standing inserts campaign and a full page print add campaign.

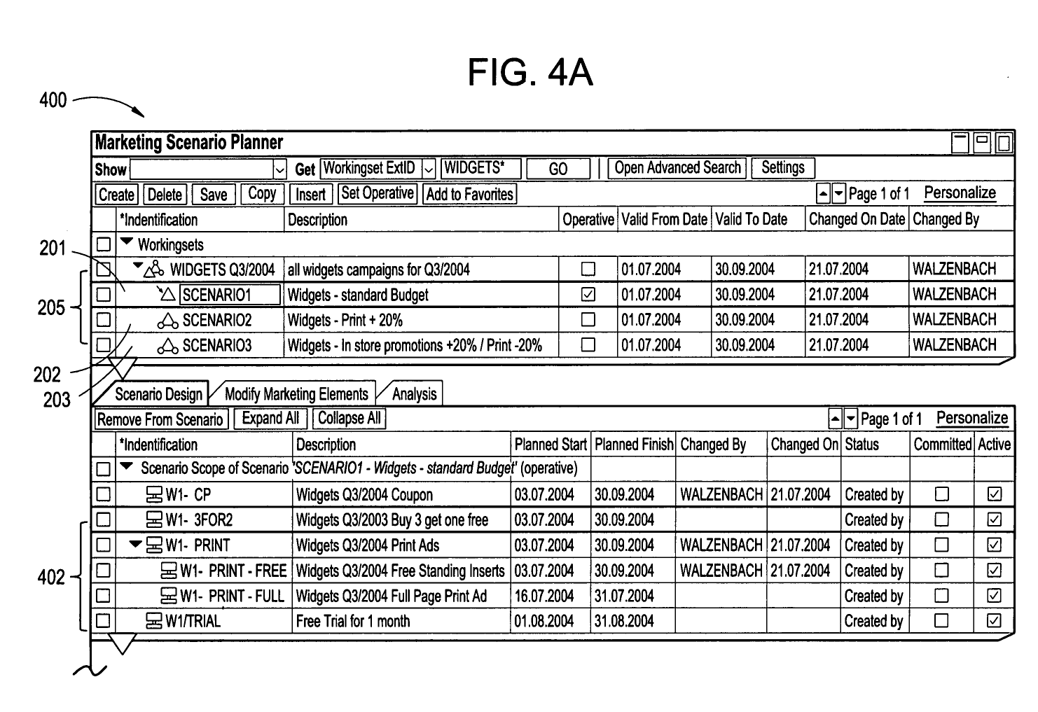

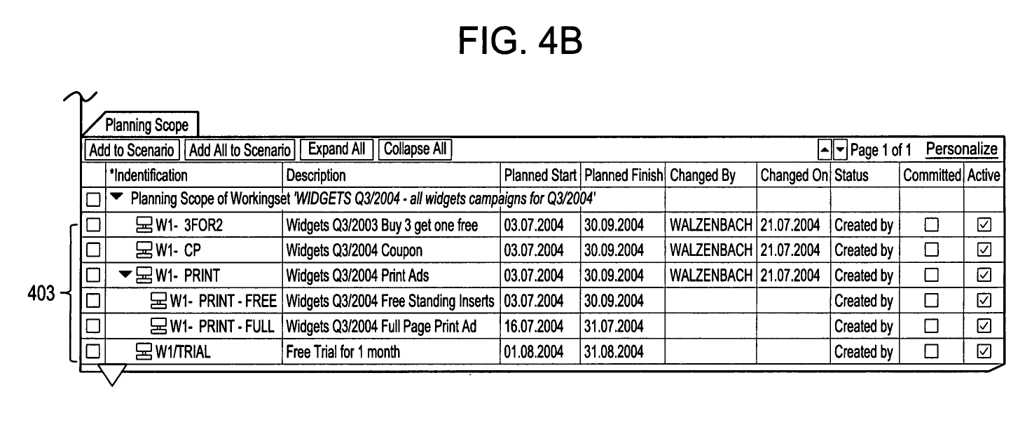

FIG. 4 is a screen shot of a screen 400 that may be used to design marketing scenarios according to an embodiment of the present invention. Screen shot 400 shows the group of scenarios 205 of FIG. 1, including scenario 201. Screen shot 400 also shows a group of marketing campaigns 402 that are contained in scenario 201, which is highlighted, and a list of marketing campaigns in a planning scope 403. A user may add marketing campaigns to the highlighted scenario 201 from any of the campaigns listed in the planning scope 403.

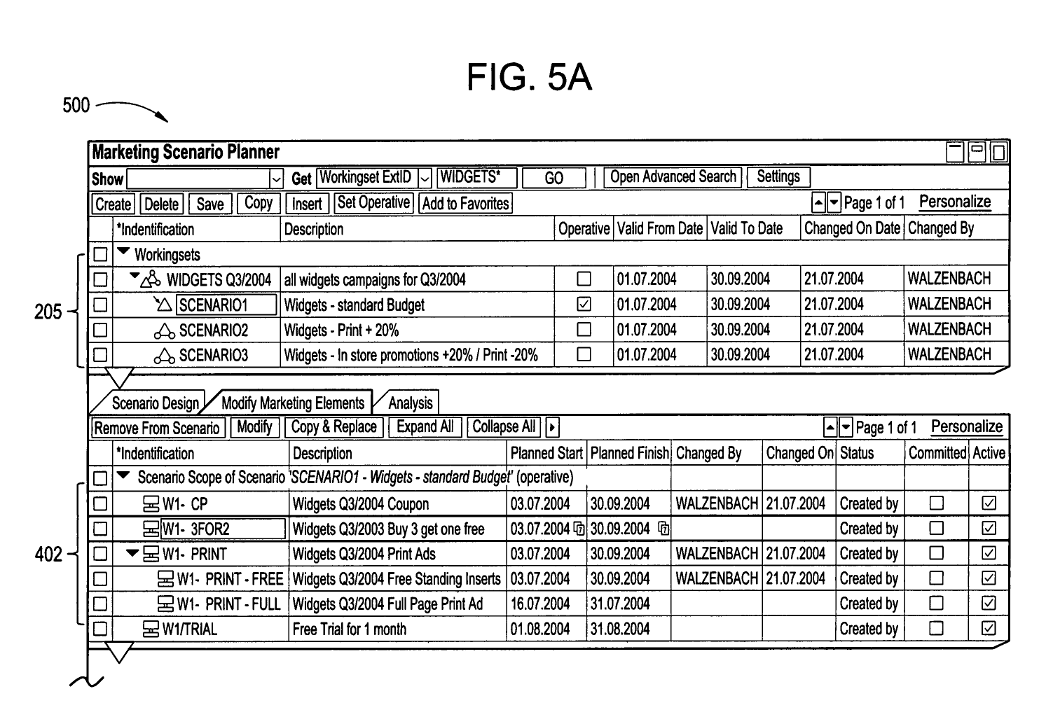

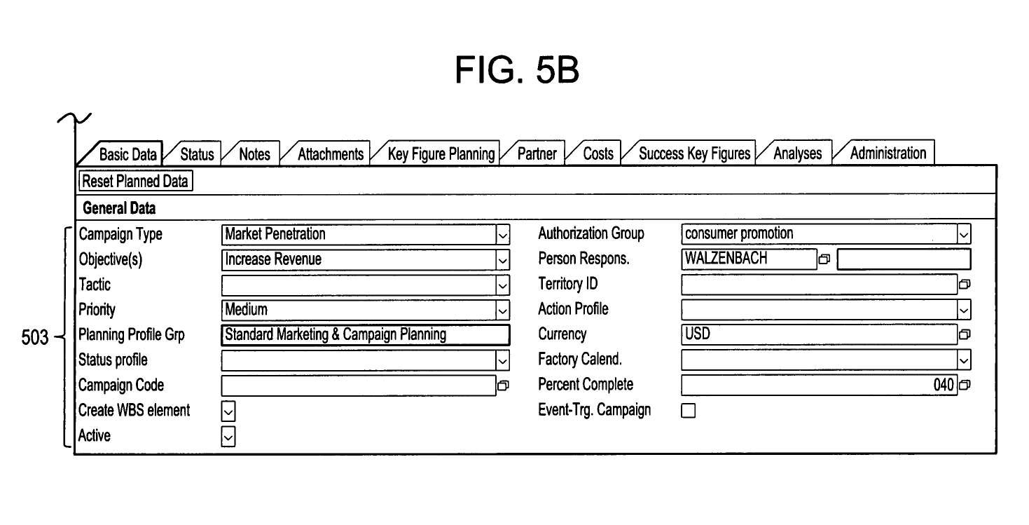

FIG. 5 is a screen shot of a screen 500 that illustrates the editing of a marketing campaign according to an embodiment of the present invention. Screen shot 500 shows scenarios 205, marketing campaigns 402 (as in FIG. 4), and marketing campaign data 503. Marketing campaign data 503 is data for the campaign that is highlighted in marketing campaigns 402 (i.e., the buy three get one free campaign). The marketing campaign data 503 that may be modified using this screen may include planning data, such as the campaign type, objectives, tactics, priority, partners, costs, person responsible, etc.

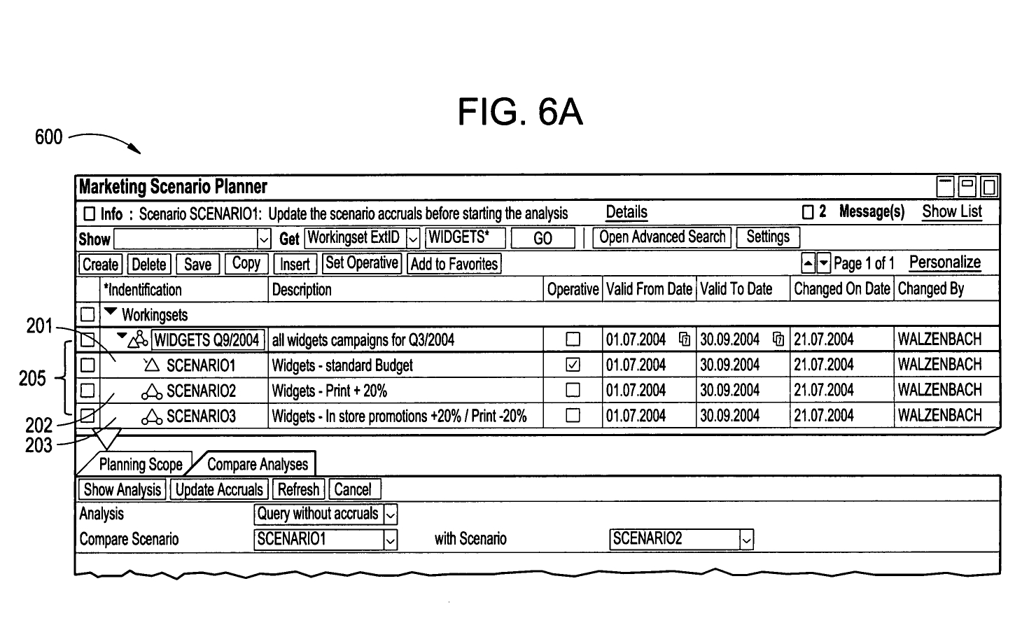

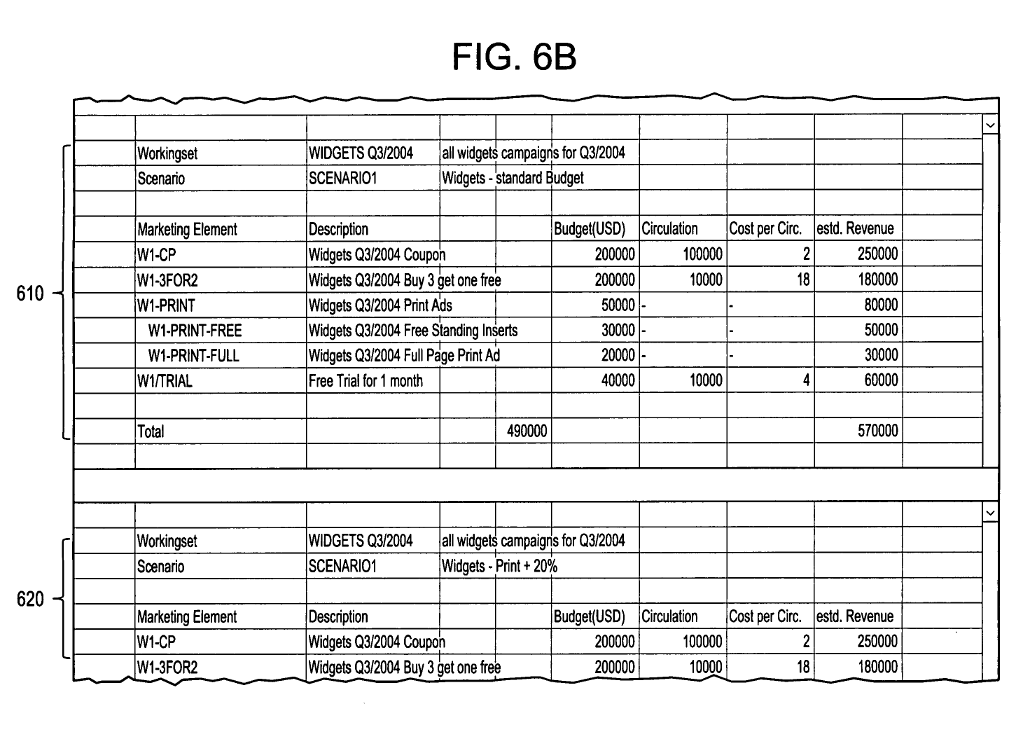

FIG. 6 is a screen shot of a screen 600 that illustrates reports for different scenarios according to an embodiment of the present invention. Screen shot 600 lists scenarios 205, a first scenario report 610, and a second scenario report 620. In the example shown, scenarios 205 contains three scenarios, which are labeled as “scenario 1” 201, “scenario 2” 202, and “scenario 3” 203. Scenario report 610 is a report for “scenario 1” 201 and scenario report 620 is a report for “scenario 2” 202. In the example shown, scenario report 610 reports information for a plurality of marketing elements, which include a coupon campaign, a buy 3 get one free campaign, a print a group of print add campaigns, and a free trial for one month campaign. In an embodiment, a user may generate a report listing all elements of a scenario, which may be launched directly from that scenario listing, or may generate a report listing the contents of all scenarios within one working set, which may be launched from the working set listing.

FIG. 7 is a flow chart that illustrates a method of planning marketing scenarios according to an embodiment of the present invention. For the purposes of illustration, this method will be discussed with reference to the apparatus of FIG. 1 and the screen shots shown in FIGS. 2-6. A computer, such as that of user 101, may receive information describing a plurality of marketing elements (701), such as marketing campaigns 402. This information may be input as new marketing campaigns, such as new marketing campaign 301, and may include information such as that shown as marketing campaign data 503. Each campaign may include a plurality of activities. For example, a user may input information for two different in-store display campaigns and three different print advertisement campaigns. Examples of activities relating to one of the in-store display campaigns may be printing and production of the displays and shipping of the displays. Other examples of information describing a campaign include planning data, such as coupon value, expected redemption rate, and coupon cost. In an embodiment, each campaign is associated with a predicted result, such as a high-end forecasted outcome and a low-end forecasted outcome. A computer may also receive information that groups the elements into a plurality of competitive scenarios (702). For example, a user may add a campaign to a scenario (such as scenario 203 of FIG. 4) from those campaigns listed in a planning scope, such as the marketing campaigns in planning scope 403. As another example, a user may assign a campaign to a scenario when the user newly adds the information for that campaign into the system. In an embodiment, one of the campaigns may be part of one, two, or more scenarios.

The system may then calculate and output a comparison of predicted results for two or more of the scenarios based on the previously received information (703). For example, a user may request that the system generate a report for two different scenarios, such as scenario 201 and 202. The system may then calculate information such as the total costs and expected results for each scenario and may output a comparison of these reports to a printer or a screen, such as scenario report 610 and scenario report 620 shown in screen shot 600. A user may then input information that modifies one of the scenarios (704). For example, a user may add a new marketing element to a scenario, such as the new campaign being added to FIG. 4. Other examples of modifications are removing a campaign from a scenario or modifying the planning data for a scenario. In an embodiment, the information modifying a scenario may be received after one of the marketing campaigns in the scenario has been executed. The system may then calculate and output a comparison of predicted results for two or more of the scenarios based on the modified information (705). Thus, for example, a user may modify one of the marketing scenarios and request a new set of reports comparing the results of a first scenario with the modified scenario. Such a user may be able to make strategic marketing decisions by considering the results of the modifications on the overall costs and results. If the result is not satisfactory (706), a user may again modify the scenario and the system may recalculate the possible result (704-705). If the result is satisfactory (706), a user may then provide information to the system that selects a scenario for execution (707). For example, the system may automatically begin executing an email campaign or may send orders necessary to begin an advertisement or coupon campaign.

In a further embodiment, at least some of the marketing. campaigns are organized into groups and information modifying at least one of the scenarios indicates that a group of marketing campaigns should be added or removed from one of the scenarios. For example, two of the marketing campaigns 402 may be associated together (such as the free standing inserts and full page print add campaigns) under a single hierarchy (such as the “print adds” marketing element) and the removal of the hierarchy may cause the removal of all associated campaigns. In an embodiment, inactive marketing elements do not affect the general system reporting, but marketing elements that are set to active are factored into such reports.

In an embodiment, the system may receive information indicating that one of the scenarios is the operative scenario because it is the scenario most likely to be executed, and based on the receipt of this information all the marketing campaigns in the operative scenario may be set to active and any other campaigns in the planning scope of the current working set that are not part of the operative scenario may be set to inactive. In an embodiment, any number of scenarios may be created within a working set of campaigns based on the planning scope. In a further embodiment, one scenario in the working set may be shown with an icon representing that it is the operative scenario. For example, in FIG. 4 scenario 201 may be shown as the operative scenario. In an embodiment, the operative scenario contains all of the active marketing elements and elements of the committed plan that are part of the planning scope of the working set. According to one embodiment, when a new working set is created the system chooses the initial scenario as the operative scenario, but any scenario may be latter selected as the operative scenario. In this embodiment, when a change is made to which scenario is selected as operative, the system may automatically set the elements of the new operative scenario to active. The other scenarios in the working set may be referred to as alternative scenarios and may represent any combination of marketing elements, whether committed, active, or inactive. Alternative scenarios may offer the possibility to do a speculative analyses at the scenario level without changing the operative scenario and to compare the outcomes of different scenarios within the working set. In an embodiment, alternative scenarios will be ignored by operative (i.e., actual data) reporting and other functions.

In an embodiment, a database record is maintained for each of the marketing campaigns, and each campaign is identified in the corresponding record as either active or inactive. For example, a database record may be maintained in the memory 125 of FIG. 1. In a further embodiment, the records for active campaigns may be accessed by software that performs applications in addition to marketing scenario planning, such as applications in knowledge warehouse system 126 in addition to marketing scenario application 128, and the only application software that accesses records for inactive marketing campaigns is marketing scenario planning software.

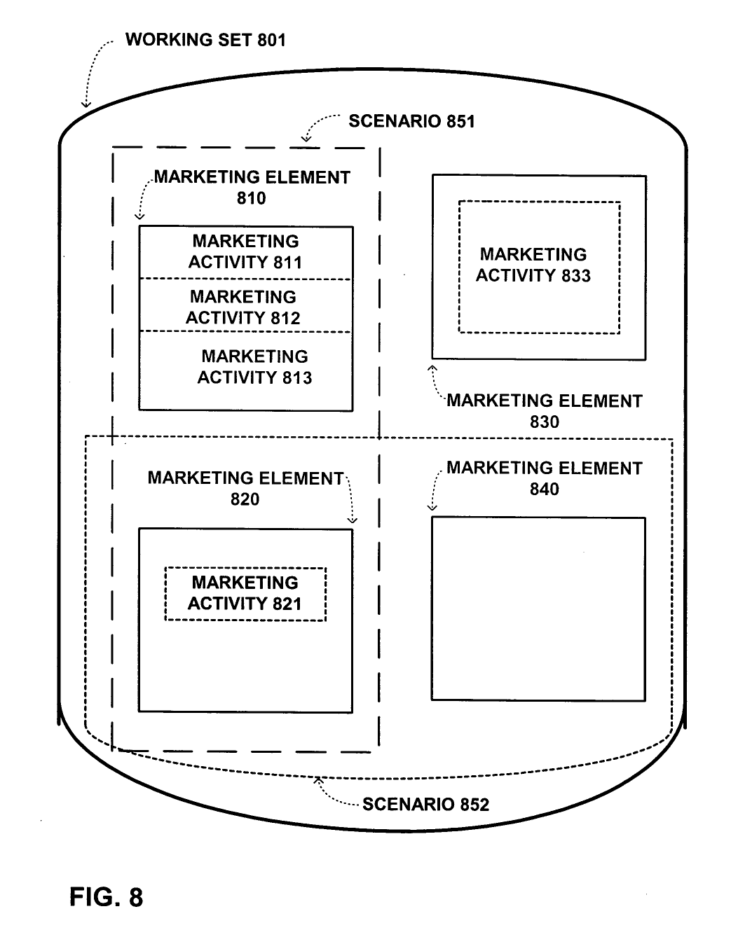

FIG. 8 is a simplified block diagram that shows data relationships according to an embodiment of the present invention. The data elements shown in FIG. 8 may be used, for example, by marketing scenario application 128. FIG. 8 shows a working set 801 that contains marketing elements 810-840. Each of these marketing elements may be a marketing campaign. As shown in FIG. 8, marketing element 810 contains marketing activities 811-813, marketing element 820 contains marketing activities 821, and marketing element 830 contains marketing activity 833. Each marketing activity is itself a marketing element. In FIG. 8, working set 801 contains scenario 851 and scenario 852. Marketing element 810 may be an in-store display marketing element that contains three separate in-store display marketing activities 811-813. Scenario 851 may be the operative scenario, such as scenario 201 of FIG. 4, and is shown in FIG. 8 as containing marketing elements 810 and 820. Scenario 852 may be an alternative scenario, such as scenario 203, and is shown as containing marketing elements 820 and 840. In this embodiment, the working set is a data object that is used by the marketing scenario planner and that contains a planning scope and a set of scenarios. A new working set may be created at the start of the scenario planning process. Scenarios that are interchangeable may be combined in the working set. There may be multiple working sets, each of which has a different planning scope. The sum of all marketing elements of all scenarios within a working set makes up the planning scope of the working set. In an embodiment, for each working set the planning scope includes the marketing elements to be considered. A user may select marketing elements individually or may select a group of marketing elements based on queries defining their characteristics or position in the marketing hierarchy.

The planning scope may be defined as a subset of the marketing elements to be considered for the scenario planning. In an embodiment, each working set has a planning scope that is used in creating scenarios. In an embodiment, when a working set is created, the system automatically creates an empty planning scope, and the planning scope may then be filled with marketing elements to use in scenario planning. In an embodiment, the planning scope may be filled by manually adding existing marketing elements or by submitting a query and filtering the marketing elements to be used. In an embodiment, the system will consider the structure of the marketing hierarchy when defining the planning scope and, for example, the lower-level marketing elements in the hierarchy will follow when adding or removing a marketing element from the planning scope. In an embodiment, existing marketing elements may be added to or removed from the planning scope. In embodiments, when a marketing element that is active is added, it will automatically be added to the operative scenario, but an inactive marketing element will be added only to the planning scope. In an embodiment, if a marketing element is removed from the planning scope, it will automatically be removed from all scenarios in the working set. In this case, removing an active marketing element from the planning scope also removes it from the operative scenario without having to set it to inactive. In an embodiment, it is not possible to create new marketing elements in the planning scope because they can only be created within a scenario.

According to an embodiment, upon initiation the system creates a working set and an operative scenario, the planning scope is filled with marketing elements, and marketing elements are added to the scenario scope. A speculative analysis may then be performed based on these scenarios and accrual reports may be generated. Alternative scenario may then be created, for example by adding marketing elements to a scenario scope, and a speculative analysis and accrual reports may be run on this new data. In addition, the scenarios may be adjusted and speculative analysis and accrual reports may be run.

In an embodiment, one or more of the following business rules may be applied when defining the planning scope of a working set. According to one possible rule, the marketing elements in the planning scope must be unique in that no element can be contained twice in the planning scope of a working set. According to another rule, all active marketing elements of the planning scope are always members of the operative scenario. In this case, the initial operative scenario is automatically filled with all active elements from the planning scope of the working set and the consistency between the operative scenario and the planning scope may be monitored by the system. According to another rule, inactive marketing elements that become active are automatically included into the operative scenario. According to a rule, when an alternative scenario becomes the operative scenario, all elements of the planning scope that are in a new operative scenario become active, and all elements that are not in this scenario become inactive. According to another rule, when a marketing element is added to the planning scope or removed, all of its subordinate marketing elements are added or removed as well. According to another rule, if a marketing element is created and located in a hierarchy that is part of the planning scope, the entire hierarchy will be expanded so that there are no gaps in the hierarchy structure between the new marketing element and the part of the hierarchy that was selected to be in the planning scope. The system may perform a consistency check in the background for the planning scope and the scenarios. If there are new elements that belong to a marketing element in the planning scope but are not listed there, the consistency check will indicate that these new elements need to be included in the planning scope.

According to an embodiment, a user may modify the operative scenario by modifying a marketing element, removing a marketing element (in which case the marketing element is set to inactive), assigning a marketing element that is in the planning scope, or creating a new marketing element. In an embodiment, whenever a new marketing element in created in the operative scenario, it is automatically set to active and added to the planning scope. In an embodiment, a user may only create a marketing element within a scenario. Users may consider the placement of the new marketing element in the marketing hierarchy. One or more alternative scenarios may be created by copying a scenario and then modifying it or by creating a new scenario and adding marketing elements to it.

In embodiments, a user may modify the alternative scenarios to represent the circumstances being considered in scenario planning by modifying a marketing element, removing a marketing element, assigning a marketing element that is in the planning scope, or creating a new marketing element. Based on the results of a speculative analyses, a user may decide to make one of the alternative scenarios the new operative scenario, in which case all marketing elements that are part of the alternative scenario are then set to active and all other marketing elements in the planning scope are set to inactive. In some embodiments, one or more of the following set of business rules may be applied during scenario design. According to a first of these rules, the elements in the scenario are to be unique. According to a second rule, an active marketing element must not have inactive higher-level elements in the marketing hierarchy. According to a third rule, when an element is added to the scenario or removed, all of its lower-level elements are added or removed as well. According to a fourth rule, an element cannot be in the scenario if its higher-level element is in the planning scope but not in the scenario. According to a fifth rule, if an inactive marketing element is added to the operative scenario, it will be set to active, as will its higher-level marketing elements.

According to an embodiment, marketing elements are considered to be part of the committed plan if they have reached a certain status (for example, they are approved and ready to be executed), whereby they are likely to become part of the operative scenario. In an embodiment, once a marketing element has become part of the committed plan, it is no longer a variable within scenario planning. For example, either the marketing element may be already underway or may be carried out very soon. In such an embodiment, a campaign that is already in the execution phase or has been approved typically would be part of the committed plan. In an embodiment, when a marketing element is in the committed plan as well as in the planning scope of a working set, it must be contained in all scenarios of that working set, and any modifications made to an element in the committed plan will have an impact on all scenarios in the working set. In an embodiment, when an element of the planning scope is set to a committed status, its change in status is automatically detected when the working set is loaded and the element is included in all scenarios of the working set. In some cases, once a marketing element is transferred to the committed plan it cannot be removed again, unless for example, the campaign is rejected. A user may be able to only make restricted modifications to marketing elements that are part of the committed plan. Certain modifications, based on the element's status, may require that the plan must be re-approved.

In an embodiment, a user may optionally request that the system schedule that accrual calculations be performed using a predefined model which may determine how the planning data is distributed to the report. Such accruals may be required for accounting purposes for actual marketing campaigns. When scenarios are being planned, there may be a number of campaigns being considered for planning purposes. Reports may be run on these scenarios using “virtual” accruals data for the planned campaigns (as opposed to actual accruals data for the actual campaigns) so that a prediction on the performance of the scenario may be made from the accounting point of view. The system may calculate the accruals for the hierarchy of the scenario that is being analyzed. This scenario hierarchy may be a subset of the marketing hierarchy. The scenario hierarchy may be updated each time that the scenario is saved, and the accrual data may be stored with the scenario name. When an analysis is selected, the system may check if the analysis requires accrual data and if accruals have already been run for the scenario.

According to an embodiment, after a user has defined scenarios, the user may evaluate their potential by performing analyses by either analyzing the outcome of an individual scenario or comparing two scenarios within a working set to decide which one provides the most optimal results. Based on the results of the analyses, a user may decide which scenario should be the operative scenario. For example, a user may select the scenario on which they want to perform the analysis and the type of analysis they want to run. Alternatively, a user may compare two scenarios by selecting the type of analysis to be performed and selecting the two scenarios from the working set that are to be compared. In embodiments, a user may choose to factor accruals into the analysis. Once the user has finished the process of scenario planning and has concluded which scenario is the most effective, the user may set this scenario as the operative scenario. To execute the scenario, the user may take the marketing elements of the operative scenario into the committed plan by manually changing the status of the marketing elements to a committed status.

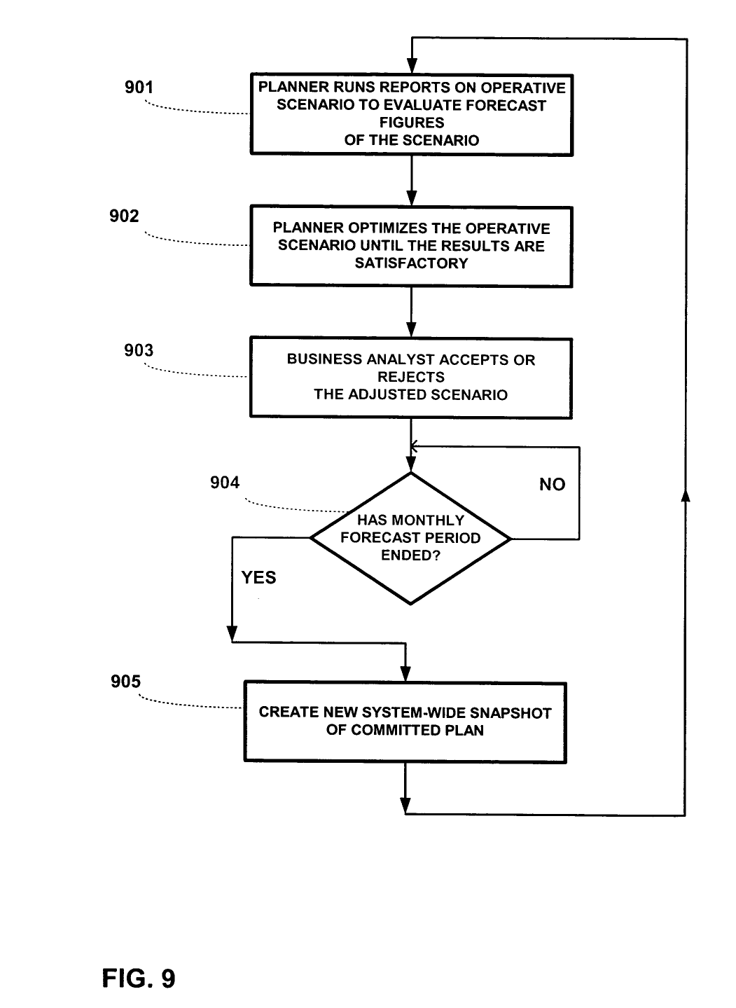

FIG. 9 is a flow chart that illustrates a method of monthly forecasting from a scenario planning point of view according to an embodiment of the present invention. In this embodiment, snapshots of the committed plan may have already been created and a snapshot of the financial forecasting data from the previous planning may already exist. According to this method, the planner may run reports on the operative scenario in order to evaluate the forecast figures of the scenario in its current configuration (901). Next, the planner may optimise the operative scenario until the results are satisfactory (902). A business analyst may then accept or reject the adjusted scenario (903). In an embodiment, this does not involve a system-supported process, but rather is organised internally. When the monthly forecast period ends (904), a new system-wide snapshot of the committed plan may then be created (905). This system-wide snapshot of the committed plan may be the basis for the analysis of the next period (901).

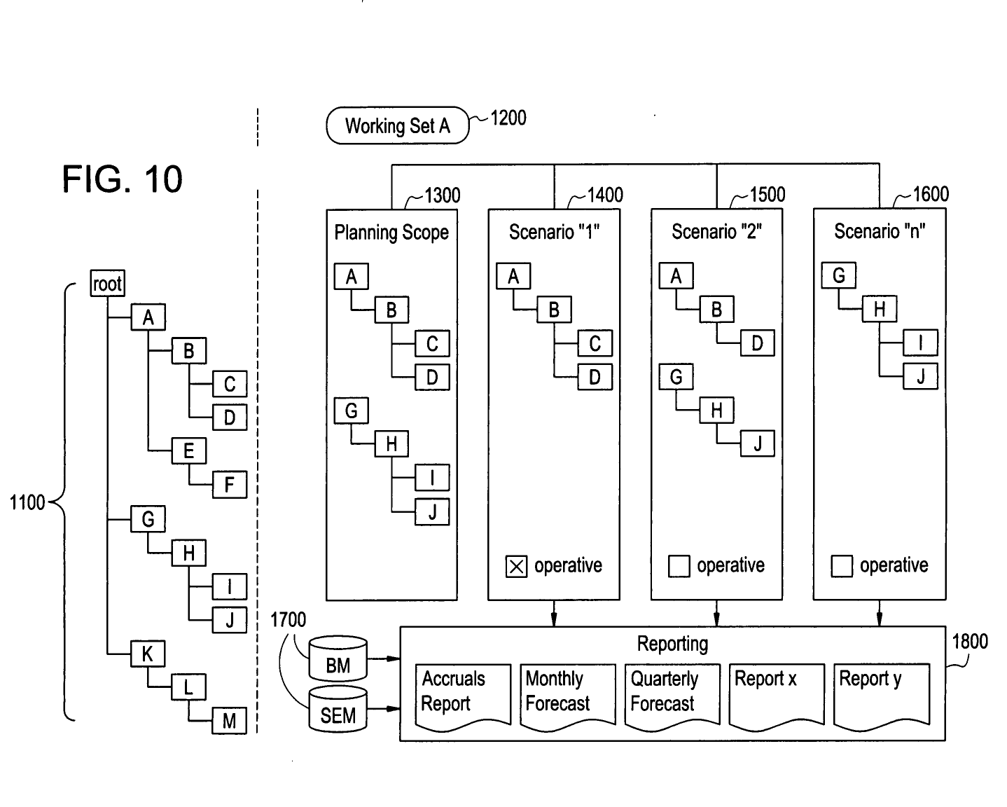

FIG. 10 is a simplified block diagram that shows data object relationships according to an embodiment of the present invention. FIG. 10 shows a plurality of marketing elements in the existing system 1100, which include marketing elements A-M that are arranged in a hierarchy based on a root. Of these, marketing elements A-F and K-M are active, and marketing elements G-I are inactive. FIG. 10 also shows a “working set A” 1200, a planning scope 1300, a “scenario 1” 1400, a “scenario 2” 1500, and a “scenario n” 1600. As shown, “scenario 1” 1400 is operative, while “scenario 2” 1500 and “scenario n” 1600 are inoperative. As shown, planning scope 1300 contains marketing elements A-D, which are active marketing elements, and marketing elements G-J, which are inactive marketing elements. “Scenario 1” 1400 contains active marketing elements A-D, “scenario 2” 1500 contains active marketing elements A, B, and D and inactive marketing elements G, H and J, and “scenario n” 1600 contains inactive marketing elements G, H, I and J. FIG. 10 also shows databases 1700 “BM” and “SEM” and a plurality of reports 1800 (Accruals Report, Monthly Forecast, Quarterly Forecast, Report x, and Report y).

In embodiments, strategic planning may cover the marketing plan for the following year and may be the basis for tactical planning and building the marketing plan structure for the year. Tactical planning may follow the strategic planning phase and, during this phase, the plan may be adjusted considering changes on the market or any optimization processes. A committed plan may contain all campaigns that are approved and ready for execution in order to exclude these campaigns from any speculative analysis. In an embodiment, only restricted changes may be allowed to campaigns in the committed plan.

In an embodiment, marketing elements may be objects commonly used in the marketing planner to represent business objects, such as campaigns, campaign elements, marketing plans, and marketing plan elements. A scenario may be an object that contains a set of marketing elements. The elements may be hierarchically structured and form a subset of the marketing elements used in the marketing planner application. In an embodiment, several scenarios may exist within one working set, one of which is always the operative scenario, with the other scenarios being alternative scenarios.

In an embodiment, multiple marketing scenarios may be created by the planner. Each scenario may be a set of marketing elements that may be hierarchically structured. Scenarios that are interchangeable may be combined in a working set. Multiple working sets may exist, each of which may have a different planning scope. The sum of all marketing elements of all scenarios within a working set may make up the planning scope of the working set. The planning scopes of the different working sets may or may not be disjunctive. Marketing elements may be used in different working sets at the same time.

The above is a detailed discussion of the certain embodiments. It may be understood that the examples discussed are for illustration purposes only and are not intended to limit the configuration to that shown. It is of course intended that the scope of the claims may cover other embodiments than those described above and their equivalents.

What is claimed is:

1. In a computer system, a method comprising:
receiving first information describing a plurality of marketing elements, wherein each marketing element is associated with a predicted result;
receiving second information that groups the marketing elements into a plurality of competitive scenarios;
calculating and outputting a comparison of predicted results for two or more of the scenarios based on the first and second information;
receiving third information modifying at least one of the scenarios; and
calculating and outputting a comparison of predicted results for two or more of the scenarios based on the first and second information as modified by the third information.

2. The method of claim 1, wherein the method further comprises receiving fourth information selecting one or more of the marketing elements for execution.

3. The method of claim 1, wherein the information modifying at least one of the scenarios indicates that a marketing element should be added or removed from one of the scenarios.

4. The method of claim 1, wherein at least some of the marketing elements are organized into groups, and wherein the information modifying at least one of the scenarios indicates that a group of marketing elements should be added or removed from one of the scenarios.

5. The method of claim 1, wherein the third information is received after one of the marketing elements have been executed.

6. The method of claim 1, wherein one of the marketing elements is part of two different scenarios.

7. The method of claim 1, wherein the result associated with a marketing element comprises a predicted high-end forecasted outcome of the marketing element and a predicted low-end forecasted outcome of the marketing element.

8. The method of claim 1, wherein the method further comprises receiving information indicating that one of the scenarios is the operative scenario, and wherein based on the receipt of this information all the marketing elements in the operative scenario are set to active and any marketing elements in the planning scope of the current working set that are not part of the operative scenario are set to inactive.

9. A machine readable medium having embodied thereon a computer program, said computer program being executable by a machine to perform a method comprising:
receiving first information describing a plurality of marketing elements, wherein each marketing element is associated with a predicted result;
receiving second information that groups the marketing elements into a plurality of competitive scenarios;
calculating and outputting a comparison of predicted results for two or more of the scenarios based on the first and second information;
receiving third information modifying at least one of the scenarios; and
calculating and outputting a comparison of predicted results for two or more of the scenarios based on the first and second information as modified by the third information.

10. The machine readable medium of claim 9, wherein the method further comprises receiving fourth information selecting one or more of the marketing elements for execution.

11. The machine readable medium of claim 9, wherein the information modifying at least one of the scenarios indicates that a marketing element should be added or removed from one of the scenarios.

12. The machine readable medium of claim 9, wherein at least some of the marketing elements are organized into groups, and wherein the information modifying at least one of the scenarios indicates that a group of marketing elements should be added or removed from one of the scenarios.

13. The machine readable medium of claim 9, wherein the third information is received after one of the marketing elements have been executed.

14. The machine readable medium of claim 9, wherein one of the marketing elements is part of two different scenarios.

15. The machine readable medium of claim 9, wherein the result associated with a marketing element comprises a predicted high-end forecasted outcome of the marketing element and a predicted low-end forecasted outcome of the marketing element.

16. The machine readable medium of claim 9, wherein the method further comprises receiving information indicating that one of the scenarios is the operative scenario, and wherein based on the receipt of this information all the marketing elements in the operative scenario are set to active and any marketing elements in the planning scope of the current working set that are not part of the operative scenario are set to inactive.
